(19) United States
(12) Patent Application Publication
(10) Pub. No.: US 2012/0210870 A1
(43) Pub. Date: Aug. 23, 2012

(54) METHOD AND DEVICE FOR SEPARATING GASEOUS MIXTURES BY MEANS OF PERMEATION

(75) Inventors: Sylvain Gerard, Suresnes (FR); Nicolas Dupont, Metz (FR); Jean-Luc Dubois, Millery (FR); Serge Tretjak, Roulhing (FR); Nabil Tlili, Metz (FR)

(73) Assignees: ARKEMA FRANCE, COLOMBES (FR); L'AIR LIQUIDE SOCIETE ANONYME POUR L'ETUDE ET L'EXPLOITATION DES PROCEDES GEORGES CLAUDE, Paris (FR)

(21) Appl. No.: 13/505,299

(22) PCT Filed: Oct. 27, 2010
(86) PCT No.: PCT/FR2010/052303

§ 371 Date: May 1, 2012

(30) Foreign Application Priority Data
Nov. 2, 2009 (FR) 0957730

(51) Int. Cl. B01D 50/00; B01D 53/14; B01D 53/22

(52) U.S. Cl. 95/45; 96/4

(57) ABSTRACT

The invention relates to a method for purifying a specific gas stream containing one or more components to be recovered, one or more impurities to be eliminated and one or more poisons, for a unit for separation by means of permeation, including the following steps: a) in a unit for separation by means of absorption, separate from said unit for separation by means of permeation, the specific gas stream is placed in contact with one or more liquid solvents suitable and intended for selectively absorbing said poisons in order to obtain at least one first gas stream depleted of said poisons and a second liquid stream; and b) said first gas stream produced in step a) is separated in said unit for separation by means of permeation, at a specific absolute pressure P, into at least one third gas stream depleted of impurities and a fourth stream; the separation performed in step a) being carried out at an absolute pressure of between 50% and 200% of said specific absolute pressure P.

The invention relates to a process and to a device for the separation of gas mixtures by permeation.

Semipermeable membranes based on hollow polymer fibers are employed in numerous separating units, for example for the treatment of natural gas, the manufacture of ammonia or methanol, the purification of hydrogen or biogas, and the like. However, the performance of units for separation by selective permeation can gradually decline as a result of the presence of certain compounds, generally in minor amounts, in their feed streams. These compounds, which will be described as “poisons”, can also result in premature aging of the membranes, which can extend as far as their rapid destruction. Various solutions exist for treating this phenomenon.

In the document EP-B-209 970, the unit for separation by permeation is found in a recycling loop of a process for the synthesis of methanol or ammonia and is placed downstream of a pretreatment unit of PSA (Pressure Swing Adsorption) type. This type of process by adjustment of pressure is a cyclical process alternating between production phase and regeneration phase. It requires complex control and numerous items of equipment and valves, which is damaging to the capital cost. Furthermore, the potential contamination of the stream to be treated by organic compounds can result in a rapid deterioration in the adsorbent or adsorbents employed in these adsorption processes, with negative consequences for the operating costs and the availability of the pretreatment unit.

The document U.S. Pat. No. B-7,318,854 describes a pretreatment for absorbing the carbon dioxide present in the feed stream of modules comprising polypropylene membranes. The absorbent used is confined in the calender part of the membrane module, outside the hollow polypropylene fibers. The process exhibits the disadvantage of being cyclical. Specifically, a phase of regeneration of the absorbent by passing a flushing gas is necessary after a phase of production of 8 hours. As a result of the cyclical nature of the process, it is necessary to install a large membrane surface area. Furthermore, the direct contact of the absorbent with the constituent components of the membrane module (polymer fibers of the membranes, leaktightness materials) requires that the materials be completely compatible and restricts the possible choices for the absorbent.

The document FR 07 04708 describes a process for the deacidification of a natural gas comprising hydrocarbons, hydrogen sulfide (H₂S) and water. In this process, the natural gas is first depleted in water during a stage of absorption with a liquid rich in H₂S. The pressure of the region in which the natural gas is brought into contact with the liquid rich in H₂S is between 45 and 75 bar. This gas, depleted in water, is subsequently separated through a membrane, so as to obtain a retentate depleted in hydrogen sulfide. The pressure of the stage of separation through the membrane is not disclosed.

The document U.S. 2004/0099138 A1 discloses a process for the production from natural gas of methane having high degrees of purity. This process comprises a stage of separation of the heavy hydrocarbon compounds of natural gas by absorption at high pressure, greater than 5.5 MPa. The absorbent is a stream rich in carbon dioxide. The stream of natural gas poor in heavy hydrocarbons is subsequently separated through a membrane, so as to obtain a retentate depleted in carbon dioxide. The pressure of the stage of separation through the membrane is not disclosed.

The document U.S. 2008/0078294 A1 discloses a process intended to separate hydrogen sulfide, carbon dioxide and hydrogen of a stream. This process comprises a stage consisting in separating the hydrogen sulfide by absorption with a solvent, in order to produce a stream poor in hydrogen sulfide. This stream poor in hydrogen sulfide is subsequently separated through a membrane, so as to obtain a permeate rich in hydrogen. The pressures of the various separation stages are not disclosed.

One aim of the invention is to overcome all or some of the disadvantages mentioned above, that is to say in particular to provide a process and a device for the separation of gas mixtures by permeation which is continuous, which minimizes the impact of certain poisons on its performance and which offers a good level of availability (long-term planned shutdown).

To this end, the invention relates to a process for the purification of a given gas stream comprising one or more constituents to be recovered, one or more impurities to be removed and one or more poisons for a unit for separation by permeation, comprising the following stages:

a) in a unit for separation by absorption, separate from said unit for separation by permeation, the given gas stream is brought into contact with one or more liquid solvents able and intended to selectively absorb said poisons, so as to obtain at least a first gas stream depleted in said poisons and a second liquid stream; and
b) said first gas stream resulting from stage a) is separated in said unit for separation by permeation, at a given absolute pressure P, into at least a third gas stream depleted in impurities and a fourth stream;
the separation carried out in stage a) being carried out at an absolute pressure of between 50% and 200% of said given absolute pressure P.

The given gas stream to be purified is of any type which can be purified by selective permeation through one or more membranes. It is essentially gaseous. It can comprise drops of liquid and/or solid particles in the form of traces. The purification operation consists essentially in removing, from this stream, one or more compounds which will be referred to as “impurities”, so as to obtain a “purified” stream, that is to say where the concentration of impurities has been lowered below a predetermined threshold. In particular, it can be a matter of removing CO₂ from a stream of syngas (H₂/CO), or a stream of hydrocarbons constituting the recycle from a process for the catalytic oxidation of hydrocarbons, or also a stream of methane.

In stage a), the given gas stream is subjected to a treatment in a unit for separation by absorption intended to remove one or more entities harmful to the membrane or membranes employed in stage b) of permeation. These compounds will be described as “poisons”. Without being limiting, compounds such as alcohols (e.g., methanol, ethanol, and the like), aldehydes (e.g., formaldehyde, acetaldehyde, acrolein, and the like), ketones (e.g., acetone, and the like), carboxylic acids (e.g., acetic acid, acrylic acid, and the like), amines, amides or aromatic compounds (e.g., benzene, toluene, and the like) can be regarded as “poisons” for polymeric semipermeable membranes. The absorption unit in question is physically separate from the permeation unit. At least one pipe occurs between the two units. There may also be in particular a heat exchanger, for adjusting the temperature of the first gas stream before it enters the permeation unit, and also a compressor.

The given gas stream is brought into contact with one or more liquid solvents, for example in a liquid/gas absorption column. Their function is to selectively absorb the poison or poisons present in the given gas stream. Selective absorption means that these solvents absorb the poisons in question more than the other substances of which the given gas stream is composed. Thus, the concentration of poisons in the given gas stream gradually falls as these poisons pass into the solvents. The solvent or solvents become progressively charged with poisons. Use may be made of one or more solvents as a function of their affinity for one or more of the poisons to be removed. Mention may be made, as examples of liquid solvents which can be used in the process according to the invention, of: water, organic solvents with a high boiling point (for example, ditolyl ether) or organic solvents with a low boiling point (toluene, cyclohexane). The second liquid stream comprises in particular the solvents and the poisons which have been removed from the starting gas stream by absorption. A portion of the absorbing compounds may possibly be re-encountered in the first stream, in a small amount, in the form of drops. Preferably, the absorbing compound is chosen so as to ensure maximum absorption of the poisons under the pressure and temperature conditions of the stage of the process and not to act itself as poison with regard to the membrane or in the remainder of the process. For example, some heavy solvents of aromatic type can be regarded as poisons for oxidation catalysts. In the process according to the invention, aqueous liquids and preferably water can be chosen as absorbing compounds as they are not a poison either for the membrane or for the catalysts preferably employed.

In stage b), the first gas stream, where the concentration of poisons has been reduced, is sent by a system of pipes to a unit for separation by selective permeation. It has to enter the permeation unit with a given absolute pressure. The unit for separation by permeation employs one or more membranes, the permeability of which with regard to the entities which it is desired to retain and the impurities which it is desired to remove is different. Mention may be made, as examples of membranes, for example, of products based on hollow fibers composed of a polymer chosen from: polyimides, polymers of cellulose derivatives type, polysulfones, polyamides, polyesters, polyethers, polyetherketones, polyetherimides, polyethylenes, polyacetylenes, polyethersulfones, polysiloxanes, polyvinylidene fluorides, polybenzimidazoles, polybenzoxazoles, polyacrylonitriles, polyazoaromatics and the copolymers of these polymers.

Thus, it is possible, according to methods known to a person skilled in the art, to separate the two types of entities. At least two new gas streams are thus obtained: a third gas stream, depleted in impurities, that is to say purified, i.e. enriched in compounds which it is desired to retain, and a fourth gas stream enriched in impurities. An enrichment corresponds to an increase in the concentration by volume of the entity or entities under consideration, while a depletion corresponds to a fall in the concentration by volume. This is on each occasion with reference to the concentration in the stream to be treated.

The main advantage to be had in removing the poisons by absorption lies in the continuous nature of the operation and its simplicity of implementation. In addition, as the permeation has to take place in stage b) at a certain absolute pressure level, the given gas stream is compressed from before stage a) of absorption. By virtue of this integration between the two stages, stage a) also benefits from a high pressure level, which reinforces its effectiveness. To do this, before the operation of separation by absorption, the given gas stream is compressed to an absolute pressure between half and twice that which is necessary for the first gas stream at the inlet of the unit for separation by permeation. It may prove to be necessary to recompress the first gas stream resulting from stage a) as a function of the level of compression of the given gas stream before stage a) and the pressure drops which it undergoes during stage a).

According to specific embodiments, the invention can comprise one or more of the following characteristics:
in stage a), said given gas stream and said liquid solvents are circulated countercurrentwise in means for facilitating the absorption of said poisons by said one or more solvents. These facilitating means can in particular be plates or packings intended to promote contact between the solvents and the given gas stream.
the process comprises a stage c) where said second liquid stream is reduced in pressure to at least one vessel where it is separated into at least a fifth liquid stream depleted in said poisons, which is recycled in whole or part in said absorption unit, and a sixth gas stream.
said sixth gas stream is added to said third gas stream depleted in impurities obtained in stage b). The sixth gas stream, rich in poisons, can optionally be combined with the purified stream resulting from stage b).

The absorbing compound or compounds employed in stage a) can be a liquid stream of aqueous or organic solvent. The solvent used is preferably water.

The circulation of the absorbing compounds preferably takes place countercurrentwise to the gases to be treated. The absorption can be carried out at a pressure close to the feed pressure of the membranes, preferably slightly greater, sufficient to compensate for the pressure drops in the items of equipment between the inlet of the column and the inlet of the unit for separation by permeation. It is generally greater by several bar than atmospheric pressure. The absorption can be carried out at the feed temperature of the water available on the site, generally less than 30° C. The combination of a relatively high pressure (several bar, with 1 bar=100 000 pascals) and a relatively low temperature (less than 30° C.) makes it possible to achieve concentrations of poisons in said first stream which are lower than if the operation were carried out at atmospheric pressure.

Furthermore, to carry out the absorption at a pressure similar to the pressure of the unit for separation by permeation makes it possible to use just one compression unit, in comparison with a solution where the absorption would be carried out at a pressure lower than that of the unit for separation by permeation.

By virtue of stage a) of absorption, the purification process according to the invention makes it possible to avoid the accumulation, in a solid and fixed adsorbent, of compounds present in small amounts in the gas to be treated and to reduce the associated risks of ignition. This is because compounds which, in very small amounts, do not represent any risk can, on accumulating, exceed a critical concentration sufficient to ignite and propagate the ignition to the treated gas and/or to the adsorbent (e.g., carbon). The accumulation of these compounds can result in their explosion. For example, aromatic compounds, such as toluene, present in a gas to be treated in very small amounts are adsorbed on an active charcoal, the treated gas also containing compounds of NOx type. If the variation in pressure and/or the increase in temperature of the process by adsorption, carried out for the regeneration, are not sufficient, the toluene remains adsorbed and can thus accumulate. The reaction for the nitration of the toluene is catalyzed by the solid support (in this instance, active charcoal). The accumulation of nitrotoluene derivatives (a powerful explosive) on an active charcoal then becomes extremely dangerous. Furthermore, the absorption, in comparison with the adsorption, exhibits a low capital cost and also a much lower sensitivity to contamination, indeed even a zero sensitivity if water is used as solvent.

In stage c), said second liquid stream resulting from the unit for separation by absorption, laden with poisons for the membrane, can be decompressed in a vessel or any equivalent means, so as to release the absorbed poisons in the form of a gas stream. The solvent or solvents, thus freed of a portion of the poisons, can be recycled to the solvent feed of the unit for separation by absorption. A purge and an extra contribution of solvent may be necessary to prevent an accumulation of poisons. In some cases, the gas stream rich in poisons can be added to the purified gas stream resulting from stage b).

If the solvents used have to be employed separately or in groups, several flash vessels and separate recycling circuits are used. The given gas stream then experiences these solvents successively during stage a) in as many reactors as necessary.

The invention also relates to a process employing at least one petrochemical unit and comprising the following successive stages:
extraction of a given gas stream from said petrochemical unit;
purification of said given gas stream and production of at least one purified gas stream; and
recycling in said petrochemical unit of at least a portion of said purified gas stream;
   characterized in that said purification of said given gas stream employs a process of purification as described above.

The purification as described above ideally applies to a petrochemical process operating at a fairly low pressure, for example less than 10 bar. The use of membranes on a stream to be recycled, at a higher pressure than said petrochemical process, generally has the aim of purging this stream of certain compounds which it is not desired to recycle in said petrochemical process.

The liquid effluent from this column, laden with poisons for the membrane, can be decompressed to the recycling pressure of said petrochemical process. The gas phase generated by this decompression, enriched in compounds harmful to the membrane, can be recycled to the petrochemical process in order to make economic use of these compounds.

The process according to the invention exhibits the advantage of not being cyclical and thus of considerably simplifying the design and the management of the pretreatment process. The operation of the pretreatment process at high pressure makes it possible to achieve very low contents of poisons to be removed from the stream sent to the unit for separation by permeation. The nature of the solvent or solvents is chosen so that the solubility of the poisons is high therein. Generally, if the poisons are hydrophilic, water will be favored as solvent; if the poisons are instead hydrophobic, a hydrophobic solvent, such as, for example, ditolyl ether, will be favored. If the poisons are of very different natures, the absorbing compound can be a miscible mixture of different solvents (for example, ditolyl ether and dimethyl phthalate) which makes possible the absorption of all the poisons without resorting to a multistage absorption process. The nature of the solvent will also be chosen so that it is not itself a “poison” for the membrane. Specifically, the solvent will be present in the purified gas sent to the unit of permeation in a concentration equal to its vapor pressure under the temperature and pressure conditions of the absorption unit.

The invention also relates to a plant for the purification of a given gas stream comprising:
a unit for separation by permeation; and
a unit for separation by absorption separate from said unit for separation by permeation, connected fluidically at the inlet to a source of said given gas stream and one or more sources of liquid solvents able and intended to absorb one or more poisons for said unit for separation by permeation 5 present in said given gas stream, a first outlet of said unit for separation by absorption being connected fluidically to said unit for separation by permeation.

“Fluidic connection” or “connected fluidically” means that there is connection via a system of pipes capable of transporting a stream of material. This connection system can comprise valves, intermediate storage tanks, side outlets, heat exchangers and compressors but not chemical reactors.

According to specific embodiments, the invention can comprise one or more of the following characteristics:
said unit for separation by absorption comprises at least one liquid/gas countercurrentwise absorption column comprising means for facilitating the absorption of said poisons into said liquid solvents.
one of said sources of liquid solvents is a vessel connected fluidically at the inlet to a second outlet of said unit for separation by absorption, this connection comprising pressure-reducing means. The pressure-reducing means are typically valves.
said vessel has at least two outlets, one of which is connected fluidically to an inlet of said unit for separation by absorption.
one of said outlets of the vessel is connected fluidically to a given outlet of said unit of permeation.
said source of said gas stream is a petrochemical unit and said given outlet of said unit of permeation is connected fluidically to an inlet of said petrochemical unit.

Said petrochemical unit, without limitation, is capable of employing and is intended to employ any one of the following processes:

1/ ammoxidation of propane and/or propylene to give acrylonitrile, of isobutane and/or isobutene to give methacrylonitrile, and of methylstyrene to give atroponitrile;
2/ oxidation of propane and/or propylene to give acrolein or acrylic acid, of isobutane and/or isobutene to give methacrolein or methacrylic acid, or of n-butane to given maleic anhydride;
3/ oxidative dehydrogenation of butene to give butadiene or of isopentene to give isoprene;
4/ oxidation of ethylene to give ethylene oxide or of ethylene to give 1,2-dichloroethane;
5/ dehydrogenation of methanol to give formaldehyde, of ethanol to give acetaldehyde, of t-butanol to give isobutene, methacrolein or methacrylic acid, or of glycerol to give acrolein or acrylic acid;
6/ oxidation of acrolein to give acrylic acid or of methacrolein to give methacrylic acid;
7/ acetoxylation of ethylene to give vinyl acetate.

### BRIEF DESCRIPTION OF THE DRAWING

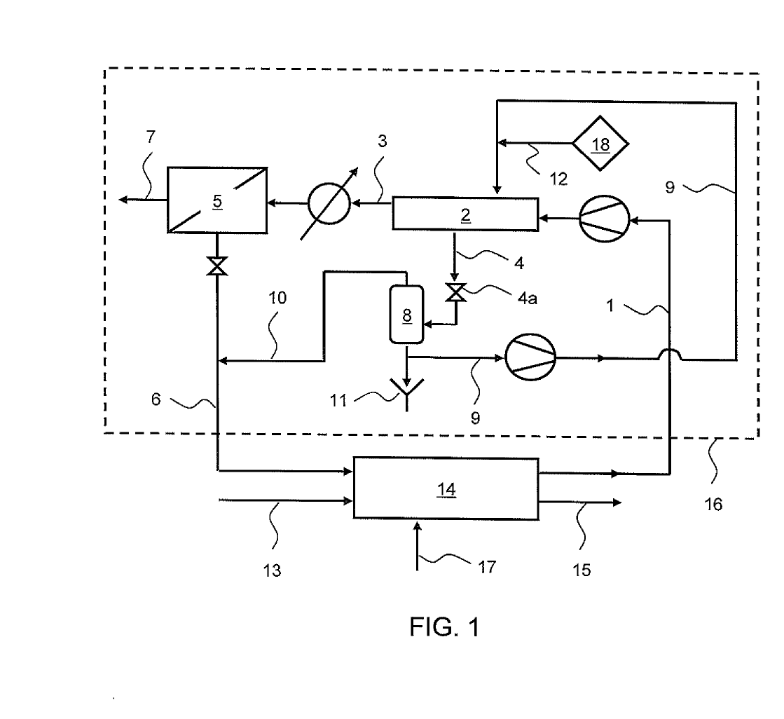

Other distinctive features and advantages will become apparent on reading the description below, made with reference to FIG. 1, which represents a diagrammatic and partial view illustrating an example of a device according to the invention.

In FIG. 1, the petrochemical process 14 is a unit for the oxidation of propylene to give acrylic acid. It converts a stream 13 of propylene, in the presence of an oxygen stream 17, into a stream 15 of acrylic acid. During the conversion, a given gas stream 1 is produced. It comprises an impurity, CO₂, a poison, acrolein, and a mixture of propane and propylene which it is desired to recycle in the petrochemical unit 14. The stream 1 is compressed to a pressure of 12 bar absolute and injected into a unit 2 for separation by absorption. The latter is composed of a plate column fed countercurrentwise with the gas stream 1 and with recycled water 9 and an extra contribution 12 originating from a source 18 of water. This unit 2 carries out stage a) of the process at a temperature of 30° C. and 12 bar abs. During the absorption, the water progressively becomes charged with poison. At the outlet of the absorption unit 2, a first stream 3 of gas depleted in poison and a stream 4 of water laden with poison are obtained.

The stream 3 is injected after heating into a unit for separation by permeation 5 at 50° C. and at a pressure of 11.5 bar abs. Said unit comprises a membrane which preferentially allows the CO₂ to pass and preferentially retains the propane and the propylene. There is collected, at the outlet of the unit 5, on the one hand, a gas stream 7 enriched in impurity and at a pressure lower than the inlet pressure of the unit 5 and a gas stream 6 enriched in propane and propylene. The stream 4 of water laden with poison is reduced in pressure in a vessel 8 via a valve 4a. This reduction in pressure separates the stream 4 into a gas stream 10 rich in poison, which is added to the purified stream 6 before recycling in the petrochemical unit 14, and a stream of water 9, laden to a lesser extent with poison, which is compressed and sent to the inlet of the absorption unit 2. A purge of liquid 11 makes it possible to avoid the accumulation of poison in the water circuit 9, 4. Means 12 make it possible to inject water, in particular for making the extra contribution.

### EXAMPLE

A petrochemical unit (14) producing 14.5 tonnes/h of acrylic acid and a gas stream (1) which is treated according to the invention.

An absorption column (2) composed of 20 plates brings 460 kmol/h of the gas stream (1) into contact countercurrentwise with 5 tonnes/h of a stream of liquid water; the gas stream (3) produced by said absorption column is depleted in poison (in this case, acrolein) and is fed to a semipermeable membrane (5) of polyetherimide type; this membrane makes it possible to produce a stream (6) depleted in CO₂, which is recycled to the unit (14), and the stream (7), which is purged or used in other units, such as furnaces. The flow rates of the main constituents of the main streams in the example are presented in the following table.

| | Stream (see FIG. 1) | | | | | |
|---|---|---|---|---|---|---|
| Compounds (kmol/h) | 13 | 17 | 1 | 3 | 6 | 7 |
| Oxygen (To be retained) | 0 | 437 | 27 | 27 | 17 | 11 |
| Propylene (To be retained) | 306 | 0 | 8 | 8 | 7 | 1 |
| Propane (To be retained) | 14 | 0 | 274 | 274 | 260 | 14 |
| CO₂ (Impurity) | 0 | 0 | 109 | 109 | 50 | 59 |
| Acrolein (Poison) | 0 | 0 | 3.6 | 0.05 | 3.5 | 0.03 |

1. A process for the purification (16) of a given gas stream (1) comprising one or more constituents to be recovered, one or more impurities to be removed and one or more poisons for a unit for separation by permeation (5), comprising the following stages:
a) in a unit for separation by absorption (2), separate from said unit for separation by permeation (5), the given gas stream (1) is brought into contact with one or more liquid solvents (9, 12) able and intended to selectively absorb said poisons, so as to obtain at least a first gas stream (3) depleted in said poisons and a second liquid stream (4); and
b) said first gas stream (3) resulting from stage a) is separated in said unit for separation by permeation (5), at a given absolute pressure P, into at least a third gas stream (6) depleted in impurities and a fourth stream (7);
the separation carried out in stage a) being carried out at an absolute pressure of between 50% and 200% of said given absolute pressure P.

2. The process of purification (16) as claimed in claim 1, characterized in that, in stage a), said given gas stream (1) and said liquid solvents (9, 12) are circulated countercurrentwise in means for facilitating the absorption of said poisons by said one or more solvents (9, 12).

3. The process of purification (16) as claimed in claim 1, characterized in that it comprises a stage c) where said second liquid stream (4) is reduced in pressure to at least one vessel (8) where it is separated into at least a fifth liquid stream (9) depleted in said poisons, which is recycled in whole or part in said absorption unit (2), and a sixth gas stream (10).

4. The process of purification (16) as claimed in claim 3, characterized in that said sixth gas stream (10) is added to said third gas stream (6) depleted in impurities obtained in stage b).

5. A process employing at least one petrochemical unit (14) and comprising the following successive stages:
extraction of a given gas stream (1) from said petrochemical unit (14);
purification (16) of said given gas stream (1) and production of at least one purified gas stream (6); and
recycling in said petrochemical unit (14) of at least a portion of said purified gas stream (6);
characterized in that said purification (16) of said given gas stream (1) employs a process of purification (16) as claimed in claim 1.

6. A plant for the purification (16) of a given gas stream (1) comprising:
a unit for separation by permeation (5); and
a unit for separation by absorption (2) separate from said unit for separation by permeation (5), connected fluidically at the inlet to a source (14) of said given gas stream (1) and one or more sources (8, 18) of liquid solvents able and intended to absorb one or more poisons for said unit for separation by permeation (5) present in said given gas stream (1), a first outlet (3) of said unit for separation by absorption (2) being connected fluidically to said unit for separation by permeation (5).

7. The plant for purification (16) as claimed in claim 6, characterized in that said unit for separation by absorption (2) comprises at least one liquid/gas countercurrentwise absorption column comprising means for facilitating the absorption of said poisons into said liquid solvents.

8. The plant for purification (16) as claimed in claim 6, characterized in that:
one of said sources of liquid solvents is a vessel (8) connected fluidically at the inlet to a second outlet (4) of said unit for separation by absorption (2), this connection comprising pressure-reducing means (4a); and
said vessel (8) has at least two outlets (9, 10), one (9) of which is connected fluidically to an inlet of said unit for separation by absorption (2).

9. The plant for purification (16) as claimed in claim 8, characterized in that one of said outlets (10) of the vessel (8) is connected fluidically to a given outlet (6) of said unit of permeation (5).

10. The plant as claimed in claim 6, characterized in that said source (14) of said gas stream (1) is a petrochemical unit and said given outlet (6) of said unit of permeation (5) is connected fluidically to an inlet of said petrochemical unit.
